(19) United States
(12) Patent Application Publication
(10) Pub. No.: US 2012/0280778 A1
(43) Pub. Date: Nov. 8, 2012

(54) Inductor having different currents for different loads

(75) Inventors: Hang Chun Lu, Hsinchu (TW); Ya Wen Yang, Hsinchu (TW); Hsiu Fa Yeh, Hsinchu (TW); Pin Yu Chen, Hsinchu (TW)

(73) Assignee: Mag. Layers Scientific Technoics Co., Ltd.

(21) Appl. No.: 13/068,164

(22) Filed: May 4, 2011

(51) Int. Cl. H01F 27/29

(52) U.S. Cl. 336/192

(57) ABSTRACT

An inductor includes a base device having a channel, a conductive device having a conductive element engaged into the channel of the base device and having two terminals, and a top device attached onto the base device and engaged with the base device, the top device includes two or more top members engaged with each other. The conductive device includes two side elements extended from the conductive element for engaging onto two end portions of the base device, and the terminals of the conductive device are extended from the side elements of the conductive device respectively. The base device includes a slot for receiving or engaging with the terminals of the side elements.

### BACKGROUND OF THE INVENTION

1. Field of the Invention

The present invention relates to an inductor, and more particularly to an inductor including different saturation currents, such as a lower current for a lower load and a greater current for a greater load, for allowing the inductor to be suitably used in various kinds of apparatuses or facilities or the like.

2. Description of the Prior Art

Typical inductors have been developed and provided for inducing the current and comprise one or more cores and one or more coils or conductive members for inducing or generating the current.

For example, U.S. Pat. No. 5,751,203 to Tsutsumi et al., and U.S. Pat. No. 7,042,324 to Watanabe disclose two of the typical inductors each also comprising one or more coils or conductive members engaged into the cores for inducing or generating the current.

However, the typical inductors may only induce or generate a limited current that may not be suitably supplied to do work and that may include an increased or greater direct current resistance such that the generated current may not suitably flow through the typical inductors.

The present invention has arisen to mitigate and/or obviate the afore-described disadvantages of the conventional inductive members or inductors.

### SUMMARY OF THE INVENTION

The primary objective of the present invention is to provide an inductor including different saturation currents, such as a lower current for a lower load and a greater current for a greater load, for allowing the inductor to be suitably used in various kinds of apparatuses or facilities or the like.

In accordance with one aspect of the invention, there is provided an inductor comprising a base device including a channel formed therein, a conductive device including a conductive element engaged into the channel of the base device, and including two terminals, and a top device attached onto the base device and engaged with the base device, the top device including a first top member and at least one second top member engaged with each other.

The conductive device includes two side elements extended from the conductive element for engaging onto two end portions of the base device and for solidly and stably anchoring or securing or retaining the conductive device to the base device.

The terminals of the conductive device are extended from the side elements of the conductive device respectively for electrically connecting or coupling to the electric power sources or reservoirs or the like.

The base device includes a slot formed therein for receiving or engaging with the terminals of the side elements for further solidly and stably anchoring or securing or retaining the conductive device to the base device and for preventing the conductive device from being disengaged from the base device.

In accordance with the other aspect of the invention, there is provided an inductor comprising a base device including a channel formed therein, and including a first base member and at least one second base member engaged with each other, a conductive device including a conductive element engaged into the channel of the base device, and including two terminals, and a top device attached onto the base device and engaged with the base device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of an inductor in accordance with the present invention;

FIG. 2 is a perspective view of the inductor;

FIG. 3 is a diagram illustrating the saturation current generated by the inductor;

FIG. 4 is an exploded view similar to FIG. 1, illustrating the other arrangement of the inductor; and

FIG. 5 is a perspective view of the inductor as shown in FIG. 4.

### DETAILED DESCRIPTION OF THE PREFERRED EMBODIMENT

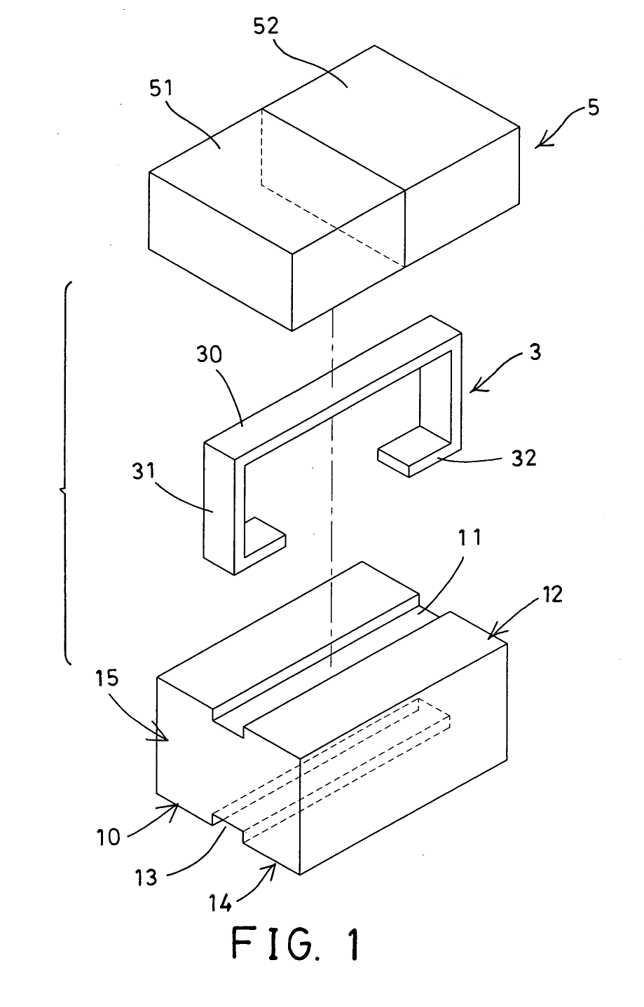

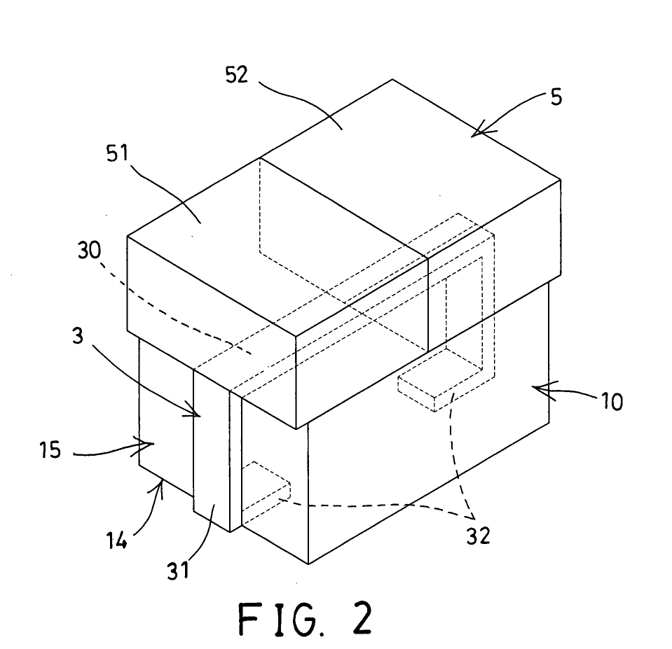

Referring to the drawings, and initially to FIGS. 1-2, an inductor in accordance with the present invention comprises a first or lower core or base device 10 including a longitudinal upper or first groove or channel 11 formed or provided on the upper portion 12 thereof, and including another longitudinal lower or second groove or slot 13 formed or provided on the lower portion 14 thereof, in which the upper channel 11 and the lower slot 13 of the base device 10 each include a depth or height smaller than the width of the upper channel 11 and the lower slot 13 of the base device 10 respectively.

A conductive device 3 is further provided and includes a central linking conductive bar or beam or element 30 having a size or dimension for snugly fitting or attaching or mounting or engaging into the upper channel 11 of the base device 10 for suitably increasing the saturation current and for allowing the inductor to be suitably used in various kinds of apparatuses or facilities or the like. The conductive device 3 further includes one or more (such as two) side bars or beams or columns or elements 31 disposed or attached or mounted or secured to the side portions of the central linking conductive element 30 for attaching or mounting or securing or engaging onto the two end portions 15 of the base device 10 and for solidly and stably anchoring or securing or retaining the conductive device 3 to the base device 10, and preferably, but not necessarily that the side elements 31 are perpendicular to the central linking conductive element 30.

The conductive device 3 further includes an extension or terminal 32 extended from each of the side elements 31, such as extended from the lower portion of each of the side elements 31 and engaged into the lower slot 13 of the base device 10 for solidly and stably anchoring or securing or retaining the conductive device 3 to the base device 10 and for electrically connecting or coupling to the electric power sources or reservoirs or the like. The central linking conductive element 30 and/or the side elements 31 and/or the terminals 32 of the conductive device 3 may include a square, flat or rectangle, elliptical or circular cross section or the like.

The inductor in accordance with the present invention further comprises a cover or second or top device 5 disposed or attached or mounted or secured onto the base device 10 and contacted or engaged with the conductive device 3 for solidly and stably anchoring or securing or retaining the conductive device 3 between the top device 5 and the base device 10. The top device 5 includes two or more top parts or segments or members 51, 52 disposed or secured together or engaged with each other for inducing or generating different saturation currents, such as a lower current for a lower load and a greater current for a greater load, for allowing the inductor to be suitably used in various kinds of apparatuses or facilities or the like.

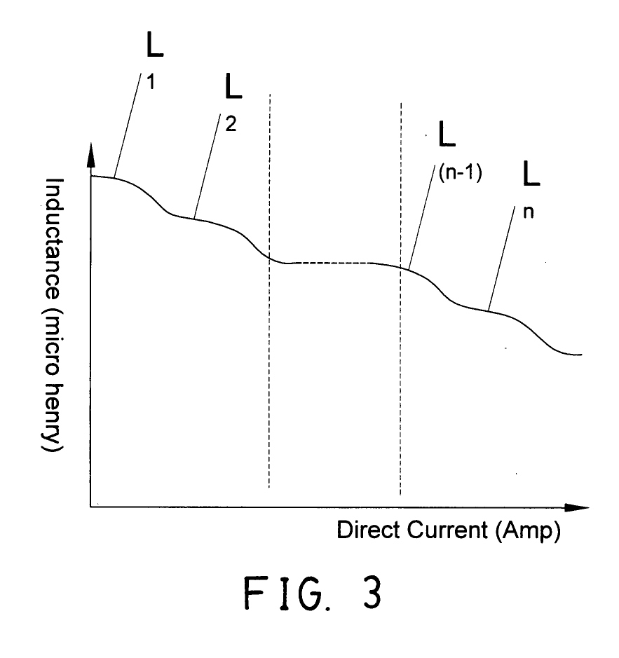

For example, as shown in FIG. 3, when the top device 5 includes two top members 51, 52, a lower load curve L1 and a greater load curve L2 will be induced or generated. Similarly, when the top device 5 includes three or more top members, such as “n” top members, one or more higher or greater load curves Ln-1, Ln, . . . will be induced or generated, and thus for allowing the inductor to be suitably used in various kinds of apparatuses or facilities or the like.

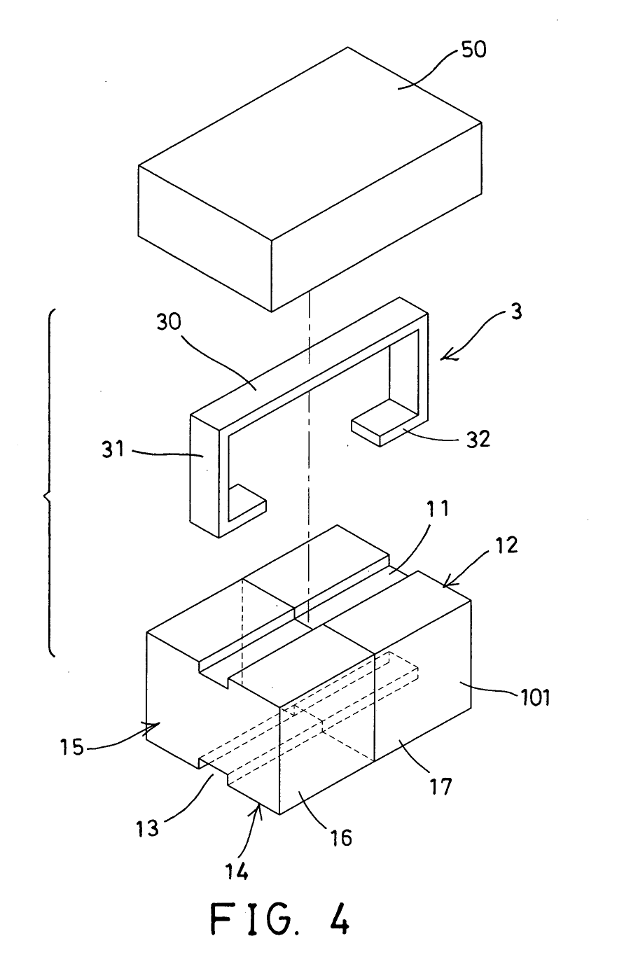

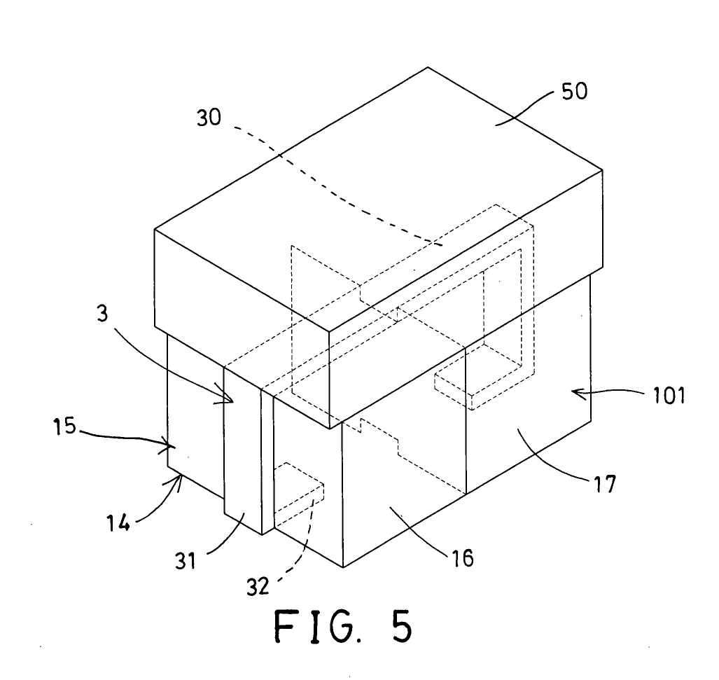

Alternatively, as shown in FIGS. 4 and 5, the top device 50 may include a single top member, but the base device 101 may include two or more base members 16, 17 for inducing or generating different saturation currents, such as a lower current for a lower load and a greater current for a greater load, and one or more higher or greater currents for even higher or greater loads, and for allowing the inductor to be suitably used in various kinds of apparatuses or facilities or the like.

Accordingly, the inductor in accordance with the present invention includes different saturation currents, such as a lower current for a lower load and a greater current for a greater load, for allowing the inductor to be suitably used in various kinds of apparatuses or facilities or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An inductor comprising:
a base device including a channel formed therein,
a conductive device including a conductive element engaged into said channel of said base device, and including two terminals, and
a top device attached onto said base device and engaged with said base device, said top device including a first top member and at least one second top member engaged with each other.

2. The inductor as claimed in claim 1, wherein said conductive device includes two side elements extended from said conductive element for engaging onto two end portions of said base device.

3. The inductor as claimed in claim 2, wherein said terminals of said conductive device are extended from said side elements of said conductive device respectively.

4. The inductor as claimed in claim 1, wherein said base device includes a slot formed therein for engaging with said terminals of said side elements.

5. An inductor comprising:
a base device including a channel formed therein, and including a first base member and at least one second base member engaged with each other,
a conductive device including a conductive element engaged into said channel of said base device, and including two terminals, and
a top device attached onto said base device and engaged with said base device.
